(19) United States
(12) Patent Application Publication
(10) Pub. No.: US 2025/0386078 A1
(43) Pub. Date: Dec. 18, 2025

(54) METHOD, APPARATUS, DEVICE, STORAGE MEDIUM AND PRODUCT FOR IMAGE PROCESSING

(71) Applicant: Beijing Zitiao Network Technology Co., Ltd., Beijing (CN)

(72) Inventors: Linquan Yu, Beijing (CN); Peihua Yu, Beijing (CN); Guanjun Guo, Beijing (CN)

(21) Appl. No.: 18/877,924

(22) PCT Filed: Sep. 4, 2023
(86) PCT No.: PCT/CN2023/116693

§ 371 Date: Dec. 20, 2024

(30) Foreign Application Priority Data
Sep. 9, 2022 (CN) 202211105138.9

(51) Int. Cl. H04N 21/472; G06T 11/60

(52) U.S. Cl. CPC H04N 21/47205; G06T 11/60

(57) ABSTRACT

The embodiments of the disclosure provide a method, an apparatus, a device, a medium, a computer program product and a computer program for image processing. The method includes: obtaining a base image and a material element; and generating a target image based on the base image and the material element; wherein the target image includes the base image and the material element, a material parameter of the material element in the base image is determined based on the base image and the material element, and the material parameter includes at least one of a material position, a material size, and a material angle.

### CROSS REFERENCE

This application claims priority to Chinese Patent Application No. 202211105138.9, entitled “METHOD, APPARATUS AND DEVICE FOR IMAGE PROCESSING,” filed before the Chinese Patent Office on Sep. 9, 2022, the entire content of which is incorporated herein by reference.

### FIELD

Embodiments of the disclosure relate to the field of computer technologies, and in particular, to a method, an apparatus, a device, a medium, a computer program product and a computer program for image processing.

### BACKGROUND

At present, a user may select a base image and a material element (a text element, an image element, etc.), and a terminal device combines the base image and the material element into an image.

In the related art, after the user selects the base image and the material element (a text element, an image element, etc.), the terminal device usually places the material element in a center position of the base image, and the user may move the material element in the base image according to actual needs to obtain a synthesized image. However, a position, an angle, a size, and the like of the material element determined by the user in the base image may be unreasonable (for example, too much material of a certain region of the base image, too many blank regions in the base image), resulting in poor aesthetics of a generated image, and cannot automatically generate an aesthetical image.

### SUMMARY

The embodiments of the disclosure provide a method, an apparatus, a device, a medium, a computer program product and a computer program for image processing.

According to a first aspect, an embodiment of the disclosure provides a method of image processing, including:
obtaining a base image and a material element; and
generating a target image based on the base image and the material element;
wherein the target image comprises the base image and the material element, a material parameter of the material element in the base image is determined based on the base image and the material element, and the material parameter comprises at least one of a material position, a material size, and a material angle.

According to a second aspect, an embodiment of the disclosure provides an apparatus for image processing, including:
an obtaining module configured to obtain a base image and a material element;
a generating module configured to generate a target image based on the base image and the material element;
wherein the target image comprises the base image and the material element, a material parameter of the material element in the base image is determined based on the base image and the material element, and the material parameter comprises at least one of the following: a material position, a material size, and a material angle.

According to a third aspect, an embodiment of the disclosure provides a device for image processing, comprising: a processor and a memory;
the memory storing computer-executable instructions;
the processor executes the computer-executable instructions stored in the memory, so that the processor executes the method of image processing according to the first aspect and various possible implementations of the first aspect.

According to a fourth aspect, an embodiment of the disclosure provides a computer-readable storage medium, wherein the computer-readable storage medium stores computer-executable instructions, which, when executed by a processor, implement the method of image processing according to the first aspect and various possible implementations of the first aspect.

According to a fifth aspect, an embodiment of the disclosure provides a computer program product, comprising a computer program, wherein the computer program is executed by a processor to implement the method of image processing according to the first aspect and various possible implementations of the first aspect.

According to a sixth aspect, an embodiment of the disclosure provides a computer program executed by a processor to implement the method of image processing according to the first aspect and various possible implementations of the first aspect.

According to a method, an apparatus, a device, a medium, a computer program product and a computer program for image processing provided by embodiments of the disclosure, after a base image and a material element are obtained, the target image may be generated based on the base image and the material element, wherein the target image comprises the base image and the material element, a material parameter of the material element in the base image is determined based on the base image and the material element, and the material parameter comprises at least one of a material position, a material size and a material angle. In the foregoing process, the material parameter (for example, a material position, a material size, a material angle, and the like) of the material element in the base image may be determined based on features of the base image and features of the material element.

### BRIEF DESCRIPTION OF DRAWINGS

In order to more clearly illustrate embodiments of the disclosure or the technical solutions in the prior art, the accompanying drawings used in the description of embodiments or the prior art will be briefly introduced below, and it will be apparent that the drawings in the following description are some embodiments of the disclosure, and those skilled in the art may also obtain other drawings according to these drawings without creative labor.

FIG. 1 is a schematic diagram of an application scenario according to an embodiment of the disclosure.

FIG. 2 is a schematic diagram of another application scenario according to an embodiment of the disclosure.

FIG. 3 is a schematic flowchart of a method of image processing according to an embodiment of the disclosure.

FIG. 4 is a schematic diagram of an image element according to an embodiment of the disclosure.

FIG. 5 is a schematic diagram of a saliency region according to an embodiment of the disclosure.

FIG. 6 is a schematic diagram of material parameters according to an embodiment of the disclosure.

FIG. 7 is a schematic flowchart of another method of image processing according to an embodiment of the disclosure.

FIG. 8 is a schematic diagram of typesetting according to an embodiment of the disclosure.

FIG. 9 is a schematic flowchart of a method of training a predetermined model according to an embodiment of the disclosure.

FIG. 10 is a schematic diagram of a sample image separation process according to an embodiment of the disclosure.

FIG. 11 is a schematic structural diagram of an apparatus for image processing according to an embodiment of the disclosure.

FIG. 12 is a schematic structural diagram of another apparatus for image processing according to an embodiment of the disclosure.

FIG. 13 is a schematic structural diagram of a device for image processing according to an embodiment of the disclosure.

### DETAILED DESCRIPTION

Example embodiments will be described in detail herein, examples of which are illustrated in the accompanying drawings. The following description refers to the accompanying drawings in which the same numbers in different drawings represent the same or similar elements unless otherwise indicated. The embodiments described in the following example embodiments do not represent all embodiments consistent with the disclosure. Rather, they are merely examples of apparatuses and methods consistent with some aspects of the disclosure as detailed in the appended claims.

The technical solution described in embodiments of the disclosure may be applied to a terminal device or a server, and the terminal device or the server may process a base image and a material element selected by a user, so as to synthesize the base image and the material element into a target image, and in the target image, the material element is located at a position suitable (for example, beautiful, unimportant information shielding, etc.) in the base image.

According to a method, an apparatus, a device, a medium, a computer program product and a computer program for image processing provided by embodiments of the disclosure, a material parameter (for example, a material position, a material size, a material angle and the like) of the material element in the base image may be determined based on features of the base image and features of the material element, the problems that the content of the base image is shielded by the material element and the distribution of the material element on the base image is unreasonable are avoided, the image can be automatically generated, and the aesthetics of the generated image is improved.

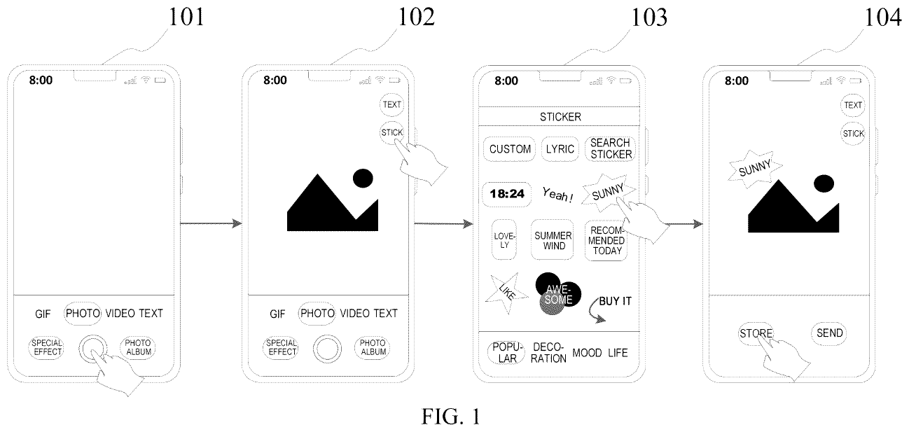

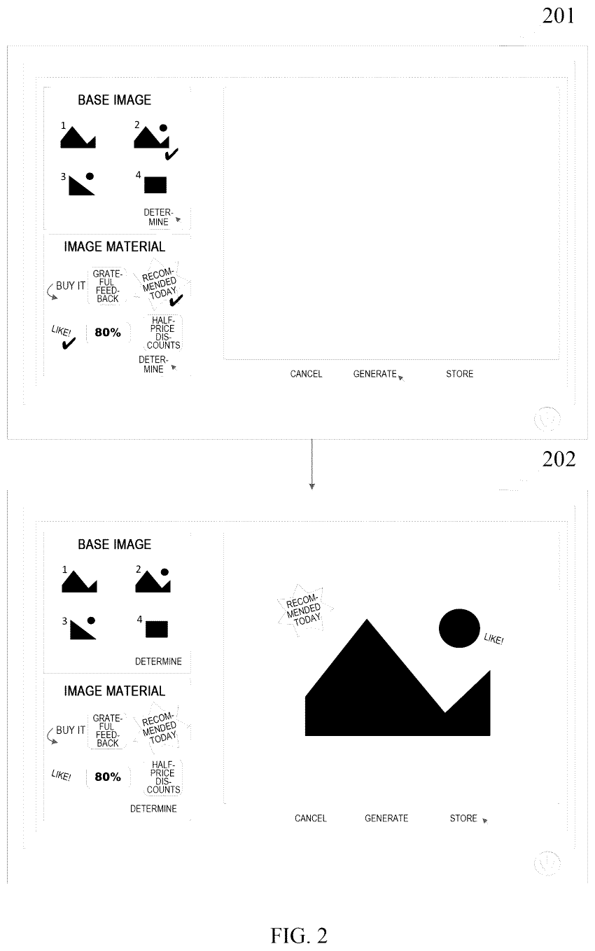

For case of understanding, an application scenario to which embodiments of the disclosure are applicable is first described with reference to FIG. 1 and FIG. 2.

FIG. 1 is a schematic diagram of an application scenario according to an embodiment of the disclosure. Please refer to FIG. 1, which includes an interface 101 to an interface 104.

Referring to the interface 101, an image generation application (not shown in the figure, hereinafter referred to as an application 1) is installed in a terminal device, and the image generation application may be a short video application. After the application program 1 is started in the terminal device, the application program 1 may call a camera apparatus to perform image shooting. For example, the application program 1 may include a shooting page shown in the interface 101, and after a user may perform a click operation on a shooting control in the shooting page, the terminal device may perform image shooting.

Referring to the interface 102, the terminal device may display the captured image. The interface may further include a text element control and a sticker control. The user may perform a click operation on the sticker control as needed to select the required sticker (material element).

Referring to the interface 103, after the user clicks on the sticker control, the terminal device may display a sticker interface, where the sticker interface includes a plurality of candidate stickers, and the user may select a corresponding sticker according to actual needs.

Referring to the interface 104, after the user selects the sticker, the terminal device may determine a parameter (for example, including a position, a size, an angle, and the like) of the sticker in the base image, and merge the sticker into the base image based on the parameter, to obtain the target image. The terminal device may further store the target image.

FIG. 2 is a schematic diagram of another application scenario according to an embodiment of the disclosure. Please refer to FIG. 2, which includes an interface 201 to an interface 202.

Referring to the interface 201, an image generation application (not shown in the figure, hereinafter referred to as an application 2) is installed in a terminal device, and the application program 2 may be a poster making application. The interface 201 includes a plurality of base images, a plurality of material elements, and a manufacturing region. The user may select a base image in the plurality of base images and select a material element in the plurality of material elements.

Referring to the interface 202, after the user selects to complete the base image and the material element, a generation control in the manufacturing region may be clicked, and the terminal device may determine material parameters (for example, including material positions, material sizes, material angles, and the like) of material elements in the base image, and merge the material elements into the base map based on the material parameters to obtain the target image. The terminal device may further include the target image.

In embodiments of the disclosure, after the base image and the material element are obtained, a material parameter of the material element in the base image may be determined based on features of the base image and features of the material element. The generated target image is determined based on the base image, the material element, and the material parameter. In the above process, since a position of the material element in the base image may be determined based on features of the base image and features of the material element, the problems that the content of the base image is shielded by the material element and the distribution of the material element on the base image is unreasonable are avoided, and the aesthetics of the generated image is improved.

The following detailed description will be given of the technical solutions of the disclosure and how to solve the above technical problems with specific embodiments. The following several specific embodiments may be combined with each other, and the same or similar concepts or processes may not be repeated in some embodiments. Embodiments of the disclosure will be described below with reference to the accompanying drawings.

FIG. 3 is a schematic flowchart of a method of image processing according to an embodiment of the disclosure. Referring to FIG. 3, the method may include steps S301 and S302 as described below.
S301: obtain a base image and a material element.

The execution body in embodiments of the disclosure may be a device for image processing, or may be an apparatus for image processing disposed in the device for image processing. The apparatus for image processing may be implemented by software, or may be implemented by combining software and hardware. The device for image processing may be a terminal device, a server, or the like.

The base image may be an image to be processed. The material element includes a text element and an image element. The material elements are used to be placed on the base image. The text element may be a text entered by the user through keyboard input. When inputting the text, the user may generate a setting page of the application program through the image, and select a font and a font size of the input text.

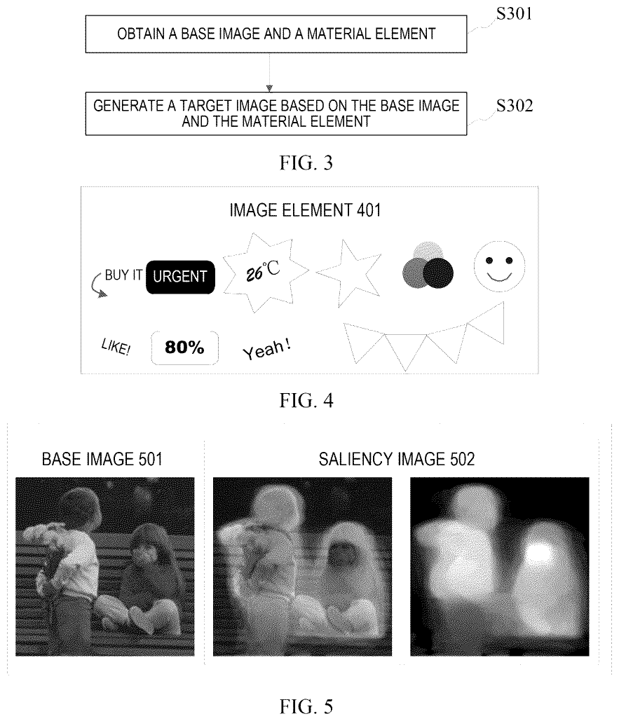

An image element is described below with reference to FIG. 4.

FIG. 4 is a schematic diagram of an image element according to an embodiment of the disclosure. Referring to FIG. 4, an image element 401 is included. The image elements 401 may include art words, decorative images, and the like.

The base image and the material element may be obtained in the following manner: obtaining the uploaded base image, and displaying the uploaded base image and a material import control: in response to an operation on the material import control, displaying a plurality of candidate materials; and in response to a selection operation performed on the material element in the plurality of candidate materials, obtaining the material element.

For example, it is assumed that an image generation process may be performed by an image generation application in the terminal device. The database corresponding to the image generation application stores a plurality of material elements. The terminal device may obtain the base image by shooting, or use an image selected by the user in the terminal device album as the base image. After the terminal device obtains the base image, the base image and the material import control may be displayed. The terminal device displays a plurality of candidate materials in a page provided by the image generation application in response to an operation performed by the user on the material import control. The terminal device obtains the material element in response to a selection operation performed on material elements in the plurality of candidate materials.
S302: generate a target image based on the base image and the material element.

The target image includes a base image and a material element, a material parameter of the material element in the base image is determined based on the base image and the material element, and the material parameter includes at least one of a material position, a material size, and a material angle.

The target image may be generated by: determining the material parameter based on a first feature of the base image and a second feature of the material element; and generating the target image based on the base image, the material element, and the material parameter.

The first feature may include a base feature and a saliency region feature.

The base feature may be a feature of the entire base image. For example, the base features may include color features, texture features, shape features, and spatial relationship features of the base image.

The saliency region feature is used to indicate a saliency region in the base image. The saliency region is described below with reference to FIG. 5.

FIG. 5 is a schematic diagram of a saliency region according to an embodiment of the disclosure. Referring to FIG. 5, a base image 501 and a saliency image 502 are included, the base image includes two persons, and a region of the two persons in the base image is a saliency region in the base image. For example, the saliency region may be a highlight region in the saliency image 502.

The material parameter of the material element in the base image may be determined as follows: obtaining the first feature and the second feature: determining a fused feature based on the first feature and the second feature; and determining the material parameter based on the fused feature.

The fused feature may be represented in a form of a vector, and a vector corresponding to the fused feature may be input into a trained predetermined model, and a material parameter is output by predetermined model.

The material parameters include at least one of a material position, a material size, and a material angle.

When the material parameter is determined, a two-dimensional coordinate system may be established based on the base image. A bottom left end point of the base image is the origin, a lower boundary is the x axis, a left boundary is the y axis, and the two-dimensional coordinate system is established. The material position may be a position corresponding to a shape center point of the material element in the base image two-dimensional coordinate system. Material size refers to material dimension. The material element may be determined as a material angle based on a predetermined point with a horizontal direction as a reference rotation angle. The predetermined point may be an end point at the lower left corner of the material element or a shape center point corresponding to the material element.

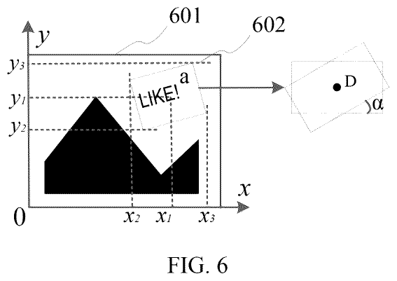

The material parameters are described below with reference to FIG. 6.

FIG. 6 is a schematic diagram of material parameters according to an embodiment of the disclosure. Referring to FIG. 6, a base image 601 and a material element 602 are included. A center point of the shape corresponding to the material element 602 is D. and a material position may be the coordinate (x1, y1) of the center point D in the two-dimensional coordinate system of the base image 501. A material size of the material element 502 may be represented by a size of the region a. If the predetermined point is that the center point of the shape corresponding to the material element 502 is D, a material angle may be an angle α that rotates based on a predetermined point with a horizontal direction as a reference.

For example, the base image is an image 1, the material element is a material element A and a material element B, and material parameters corresponding to the material element may be specifically shown in Table 1:

TABLE 1

| Material | Material | Material | Material |
|---|---|---|---|
| Elements | Location | Size | Angle |
| Material | (x1, y1) | Size 1 | 45° |
| Element A | | | |
| Material | (x3, y3) | Size 2 | 0° |
| Element B | | | |

According to the material parameters shown in Table 1, a size of the material element A is set to the size 1, the size adjusted material element A is added to the image 1, and the center point of the material element A is located (x1, y1). The material element A may be also rotated by 45° based on a predetermined point, with a horizontal direction as a reference. A size of the material element B is set to size 2, the size adjusted material element B is added to the image 1, and the center point of the material element B is located (x3, y3). After the position of each material element in the image 1 is determined based on the material parameter, a target image is generated.

After the target image is determined based on the base image, the material element, and the material parameter, the target image may be directly displayed, or the target image may be sent to the terminal device.

According to the method of image processing provided by embodiment of the disclosure, after a base image and a material element are obtained, the target image may be generated based on the base image and the material element, wherein the target image comprises the base image and the material element, a material parameter of the material element in the base image is determined based on the base image and the material element, and the material parameter comprises at least one of a material position, a material size and a material angle. In the foregoing process, since the material parameter (for example, the material position, the material size, the material angle, and the like) of the material element in the base image may be determined based on features of the base image and features of the material element, the problems that the content of the base image is shielded by the material element and the distribution of the material element on the base image is unreasonable are avoided, the image can be automatically generated, and the aesthetics of the generated image is improved.

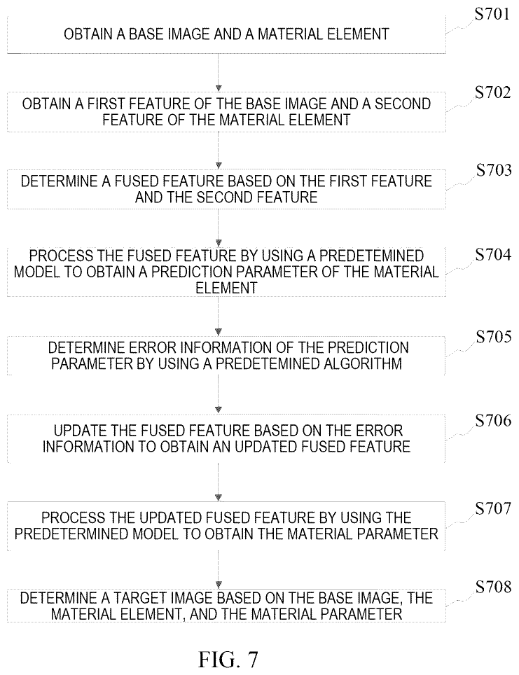

Based on any one of the foregoing embodiments, optionally, the material parameter of the material element may be determined by using a trained predetermined model. The following describes in detail the embodiment shown in FIG. 7.

FIG. 7 is a schematic flowchart of another method of image processing according to an embodiment of the disclosure. Referring to FIG. 7, the method includes the following steps S701 to S708.
S701: obtain a base image and a material element.

The base image and the material element may be obtained in the following manner: displaying a first page comprising a plurality of candidate images and a plurality of candidate materials; in response to a selection operation input to the base image in the plurality of candidate images, obtaining the base image; and in response to a selection operation input to the material element in the plurality of candidate materials, obtaining the material element.

The base image and the material element may be obtained through a page provided by an image generation application in a terminal device.

For example, in the terminal device, the image generation application is an application A. When the base image and the material element are obtained, the terminal device may display a first page in the application A, and the first page may include a plurality of candidate images and a plurality of candidate materials. After a user selects the image 2 in the plurality of candidate images, the image 2 is determined as the base image. After the user selects the material 5 and the material 8 in the plurality of candidate materials, the material 5 and the material 8 are determined as the material element. For example, a larger number of advertisement images may be made based on a product image and a material library provided by the manufacturer.
S702: obtain a first feature of the base image and a second feature of the material element.

The first feature of the base image and the second feature of the image element may be obtained through an image feature extraction algorithm.

If the material element includes a text element, a font feature of the text element may be encoded, and the second feature of the text element may be determined based on the code corresponding to the font feature of the text element. Each font feature has its corresponding code.

The first feature and the second feature may be identified by a vector.
S703: determine a fused feature based on the first feature and the second feature.

The fused feature may be determined by: obtaining a random vector, and obtaining a random feature of the random vector: performing fusion processing on the random feature, the first feature, and the second feature to obtain the fused feature.

The fused features may be represented in the form of vectors. For example, a random vector may be obtained in a normal distribution curve.

In the process of performing feature fusion, by adding a random vector, the determined fused feature may be diversified. For example, when the added random vectors are different, the fused features may be different.

For example, the base image is an image 1, and the material element is a decorative image 1. The feature vector corresponding to the first feature of the image 1 includes a vector A and a vector B, and the feature vector corresponding to the second feature of the decoration image 1 is a vector C. When determining the fused feature, a random vector X may be obtained, and the vector A, the vector B, the vector C, and the random vector X may be fused to obtain a vector Z corresponding to the fused feature.
S704: process the fused feature by using a predetermined model to obtain a prediction parameter of the material element.

Inputting a vector corresponding to the fused feature into a predetermined model, and the predetermined model outputs the prediction parameter of each material element based on the vector corresponding to the fused feature. The prediction parameters include a predicted material position, a predicted material size, and a predicted material angle.

For example, the base image is an image 1, and the material element includes a decorative image A and a text 1. A fused feature vector corresponding to the image 1, the decorative image A, and the text 1 is Z. The vector Z corresponding to the fused feature is input into the predetermined model. The predetermined model outputs the prediction parameter of the decorative image A and the prediction parameter of the text 1 based the vector Z corresponding to the fused feature. For example, the output prediction parameters of the decorative image A and the text 1 may be specifically as shown in Table 2:

TABLE 2

| Material | prediction | prediction | prediction |
|---|---|---|---|
| Elements | material location | material size | material angle |
| Decorative | (x1, y1) | Size 1 | 0° |
| Image A | | | |
| Text 1 | (x2, y2) | Size 2 | 30° |

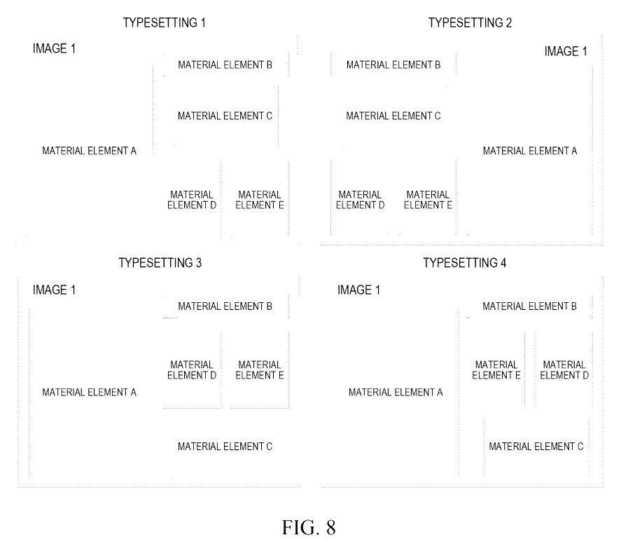

Optionally, different random vectors used in performing feature fusion in S703 may make the determined prediction parameters different, so that typesetting of the material elements in the base map is different. The following describes in conjunction with FIG. 8.

FIG. 8 is a schematic diagram of typesetting according to an embodiment of the disclosure. Referring to FIG. 8, a typesetting 1-typesetting 4 is included, wherein a base image and a material element corresponding to each typesetting are the same. For example, the base image corresponding to each typesetting is an image 1, and the material element includes a material element A, a material element B, a material element C, a material element D, and a material element E.

Referring to FIG. 8, the random vectors corresponding to each typesetting are different, that is, when the random vectors added during feature fusion are different, the typesetting is different. The same material can obtain different generated images.
S705: determine error information of the prediction parameter by using a predetermined algorithm.

The error information may indicate a degree of occlusion between the material elements, a degree of the material element exceeding a boundary of the base image, and the like.

The predetermined algorithm may be a predetermined loss function.

For example, the predetermined algorithm may include a Lagrange optimization algorithm, a Covariance Matrix Adaptation Evolutionary Strategies (CMA-ES) algorithm, and the like.
S706: update the fused feature based on the error information to obtain an updated fused feature.

The S706 may be performed only when the error information is greater than or equal to the predetermined threshold. In this way, unnecessary updating of the fused feature may be avoided.

The fused feature may be updated based on the error information by using an optimization algorithm, and the optimization algorithm may include a Lagrangian optimization algorithm, a Covariance Matrix Adaptation Evolutionary Strategies (CMA-ES) algorithm, and the like.
S707: process the updated fused feature by using the predetermined model to obtain the material parameter.

Optionally, after the updated fused feature is processed, an accurate material parameter cannot be obtained (the error information is small), the material parameter may be determined as the prediction parameter, and S705 is performed again, so that the determined error of the material parameter may be relatively small.
S708: determine a target image based on the base image, the material element, and the material parameter.

For the execution process of S708, refer to the execution process of S303, and details are not described herein again.

According to the method of image processing provided by embodiments of the disclosure, after the base image and the material element are obtained, the first feature of the base image and the second feature of the material element are determined. The fused feature is determined based on the first feature and the second feature. The fused feature is processed through a predetermined model to obtain a prediction parameter of the material element. The error information of the prediction parameter is determined by using a predetermined algorithm. Updating the fused feature based on the error parameter to obtain an updated fused feature, and determining the material parameter based on the updated fused feature. In the above process, since a position of the material element in the base image can be determined based on features of the base image and features of the material element, the problems that the content of the base image is shielded by the material element and the distribution of the material element on the base image is unreasonable are avoided, and the fused feature can be updated based on the error information, so that the problem caused by inaccurate prediction parameters of the predetermined model is avoided, and the aesthetics of the generated image is improved.

The process of training the predetermined model is described below with reference to FIG. 9.

FIG. 9 is a schematic flowchart of a method of training a predetermined model according to an embodiment of the disclosure. Referring to FIG. 9, the method includes the following steps S901 to S909.
S901: obtain a sample image.

The sample image may include a sample base map and a sample material. The sample material may include a text and a decorative image. The processed and clear and beautiful image may be used as a sample image.
S902: perform separation processing on the sample image to obtain a sample base map and a sample material.

The sample image may be separated by: performing an image mask processing on the sample image, extracting and determining a content and a position of the sample material in the sample base map, determining a material parameter of the sample material based the content and the position of the sample material in the sample base map, and deleting the sample material in the sample image by using an image repair algorithm to obtain the sample base map. The material parameters include a material position, a material size and a material angle.

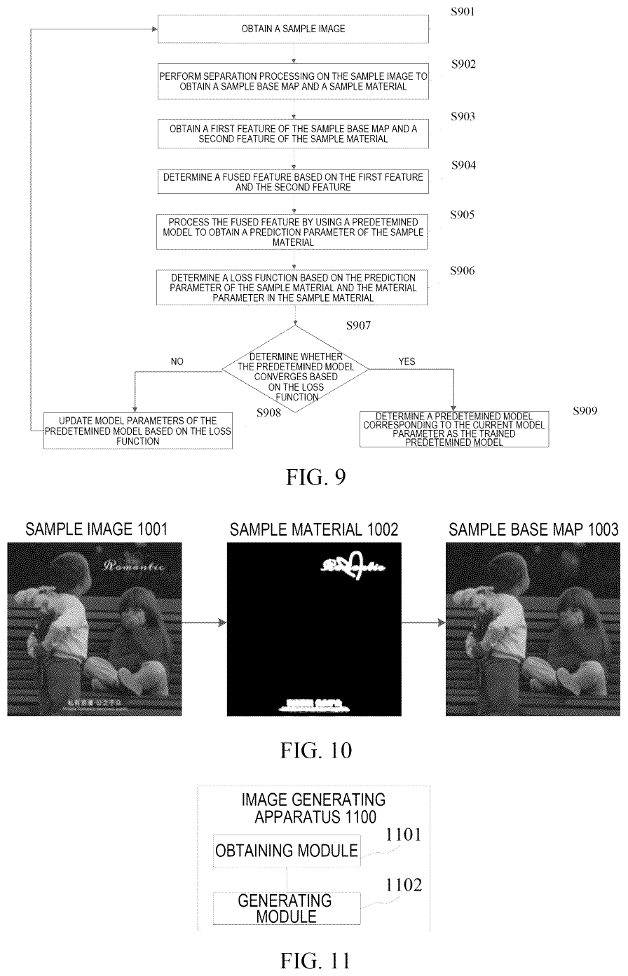

The process of separating the sample image is described below with reference to FIG. 10.

FIG. 10 is a schematic diagram of a sample image separation process according to an embodiment of the disclosure. Referring to FIG. 10, a sample image 1001, a sample material 1002, and a sample base map 1003 are included. The sample image 1001 includes 2 material elements. When the sample image 1001 is separated, a content and a position of the 2 material elements in the sample image 1001 are first determined, and the content and the position of the material element in the sample image 1001 arc determined and extracted through image mask processing to obtain the sample material 1002. Based on the sample material 1002, the material parameter of the sample material 1002 may be determined, and the 2 sample materials in the sample image 1001 are deleted by using the image repair algorithm to obtain the sample base map 1003.
S903: obtain a first feature of the sample base map and a second feature of the sample material.

It should be noted that the execution process of S803 may refer to S702, and details are not described herein again.
S904: determine a fused feature based on the first feature and the second feature.

Fusing the first feature and the second feature to obtain a fused feature.

In addition to the material parameters that need to approach the sample material, the prediction parameters output by the predetermined model may further output diversified material parameters on the basis of generating a clear and beautiful target image, so that the sample material typesetting in the generated target image has diversity. Therefore, in the training model, a random vector may be obtained in the normal distribution curve, and a random feature of the random vector may be obtained. Performing fusion processing on the random feature, the first feature, and the second feature to obtain a fused feature.
S905: process the fused feature by using a predetermined model to obtain a prediction parameter of the sample material.

The predetermined model may be an initial model or a model updated in a training process. For example, if the current model is trained as the first iteration process, the predetermined model may be an initial model; and if the current model is trained as the Nth (N is an integer greater than or equal to 2), the predetermined model may be an updated model in the training process.

For the execution process of S905, refer to the execution process of S704, and details are not described herein again.
S906: determine a loss function based on the prediction parameter of the sample material and the material parameter in the sample material.

The loss function is used to indicate a difference between the prediction parameter and the material parameter.
S907: determine whether the predetermined model converges based on the loss function.

If yes, perform S908.

If no, perform S909.

The convergence condition of the predetermined model may include: the loss function is less than the predetermined threshold, and/or the loss function no longer changes during many recent iterations.
S908: update model parameters of the predetermined model based on the loss function.

After S908, perform S901.
S909: determine a predetermined model corresponding to the current model parameter as the trained predetermined model.

According to the method of training the predetermined model provided by the embodiment of the disclosure, after the sample image is obtained, the sample image can be separated to obtain the sample base map and the sample material. Performing fusion processing on the first feature of the sample base map and the second feature of the sample material to obtain a fused feature. The fused feature is processed through a predetermined model to obtain a prediction parameter of the sample material. Determining a loss function based on the prediction parameter of the sample material and the material parameter in the sample material. Determining whether the predetermined model converges based on the loss function. If not, the model parameters are updated, and the above process is repeated until the predetermined model converges. If yes, it is determined that the predetermined model corresponding to the current model parameter is the trained predetermined model. In the foregoing process, the predetermined model may be trained based on the sample image, and the material parameter output by the predetermined model may be diversified by using the random feature of the random vector. The problems that the content of the base image is shielded by the material elements and the distribution of the material elements on the base image is unreasonable are avoided, and the accuracy of outputting the material parameters through the predetermined model is improved.

Based on any of the foregoing embodiments, the process of image processing is illustrated below.

It is assumed that an image processing process may be performed by using an image generation application in a terminal device. The image generation application may be an application 1. The database corresponding to the application program 1 stores a plurality of material elements. The terminal device uses an image 1 selected by the user in the terminal device album as the base image. After the terminal device obtains the image 1, the image 1 and a material import control may be displayed. The terminal device displays a plurality of candidate materials in a page provided by the application program 1 in response to an operation performed by the user on the material import control. The terminal device obtains a material A and a material B in response to an operation of selecting the material A and the material B from the material elements in the plurality of candidate materials.

The terminal device determines a first feature of the image 1 based on the image 1 selected by the user. The first feature includes a base image feature and a saliency region feature. The terminal device determines a second feature of a material 1 and a second feature of a material 2 based on the material 1 and the material 2 selected by the user. The vectors corresponding to the determined first feature and the second feature may be specifically as shown in Table 5:

TABLE 5

| | |
|---|---|
| Image Features | Vector |

| | | |
|---|---|---|
| First Features | Base Image Features | A1 |
| | Saliency Region Features | A2 |
| Second Features | Second Features of Material 1 | B |
| | Second Features of Material 2 | C |

According to Table 5, the terminal device determines that a feature vector corresponding to the first feature of the image 1 includes a vector A1 and a vector A2, a feature vector corresponding to the second feature of the material 1 is vector B, and a feature vector corresponding to the second feature of the material 2 is vector C. When determining the fused feature, the terminal device obtains a random vector X, and performs fusion processing on the vector A1, the vector A2, the vector B, the vector C, and the random vector X to obtain a vector Z corresponding to the fused feature.

The terminal device inputs the vector Z corresponding to the fused feature into the predetermined model. The predetermined model outputs the prediction parameter of the material 1 and the prediction parameter of the material 2 based on the vector Z corresponding to the fused feature. The output prediction parameters of the material 1 and the material 2 may be specifically as shown in Table 6:

TABLE 6

| Material | Prediction | Prediction | Prediction |
|---|---|---|---|
| Elements | material location | material size | material angle |
| Material | (x1, y1) | Size 1 | 0° |
| Element 1 | | | |
| Material | (x2, y2) | Size 2 | 30° |
| Element 2 | | | |

The terminal device determines error information of the prediction parameter by using a predetermined algorithm. The terminal device may update the fused feature based on the error information by using an optimization algorithm, to obtain an updated fused feature. A vector corresponding to the updated fused feature is Z1. The terminal device processes the updated fused feature Z1 by using a predetermined model to obtain the material parameter. The terminal device merges the material element 1 and the material element 2 into the image 1 based on the material parameter, to obtain the target image.

According to the method of image processing provided by the embodiment of the disclosure, after the base image and the material element are obtained, the first feature of the base image and the second feature of the material element are determined. The fused feature is determined based the first feature and the second feature. The fused feature is processed through a predetermined model to obtain a prediction parameter of the material element. The error information of the prediction parameter is determined by using a predetermined algorithm. Updating the fused feature based on the error parameter to obtain an updated fused feature, and determining the material parameter based on the updated fused feature. In the above process, since a position of the material element in the base image can be determined based features of the base image and features of the material element, the problems that the content of the base image is shielded by the material element and the distribution of the material element on the base image is unreasonable are avoided, and the fused feature can be updated based on the error information, so that the problem caused by inaccurate prediction parameters of the predetermined model is avoided, and the aesthetics of the generated image is improved.

FIG. 11 is a schematic structural diagram of an apparatus for image processing according to an embodiment of the disclosure. Referring to FIG. 11, the apparatus 1100 for image processing includes:
an obtaining module 1101 configured to obtain a base image and a material element;
a generating module 1102 configured to generate a target image based on the base image and the material element;
wherein the target image comprises the base image and the material element, a material parameter of the material element in the base image is determined based on the base image and the material element, and the material parameter comprises at least one of a material position, a material size, and a material angle.

The apparatus for image processing provided by the embodiments of the disclosure may be configured to perform the technical solutions of the foregoing method embodiments, and implementation principles and technical effects thereof are similar, and details are not described herein again in this embodiment.

In a possible implementation, the obtaining module 1101 is specifically configured to:
obtain the uploaded base image, and display the uploaded base image and a material import control;
in response to an operation on the material import control, display a plurality of candidate materials; and
in response to a selection operation performed on the material element in the plurality of candidate materials, obtain the material element.

In a possible implementation, the obtaining module 1101 is specifically configured to:
display a first page comprising a plurality of candidate images and a plurality of candidate materials;
in response to a selection operation input to the base image in the plurality of candidate images, obtain the base image; and
in response to a selection operation input to the material element in the plurality of candidate materials, obtain the material element.

In a possible implementation, the generating module 1102 is specifically configured to:
determine the material parameter based on a first feature of the base image and a second feature of the material element; and
generate the target image based on the base image, the material element, and the material parameter.

In a possible implementation, the generating module 1102 is specifically configured to:
process the fused feature by using a predetermined model to obtain a prediction parameter of the material element; and
determine the material parameter based on the prediction parameter.

In a possible implementation, the generating module 1102 is specifically configured to:
determine error information of the prediction parameter by using a predetermined algorithm;
update the fused feature based on the error information to obtain an updated fused feature; and
process the updated fused feature by using the predetermined model to obtain the material parameter.

In a possible implementation, the generating module 1102 is specifically configured to:
obtain a random vector, and obtain a random feature of the random vector;
perform fusion processing on the random feature, the first feature, and the second feature to obtain the fused feature.

In a possible implementation, the generating module 1102 is specifically configured to:
obtain a base feature of the base image;
perform saliency region detection on the base image to obtain a saliency region feature of the base image;
wherein the first feature comprises the base feature and the saliency region feature.

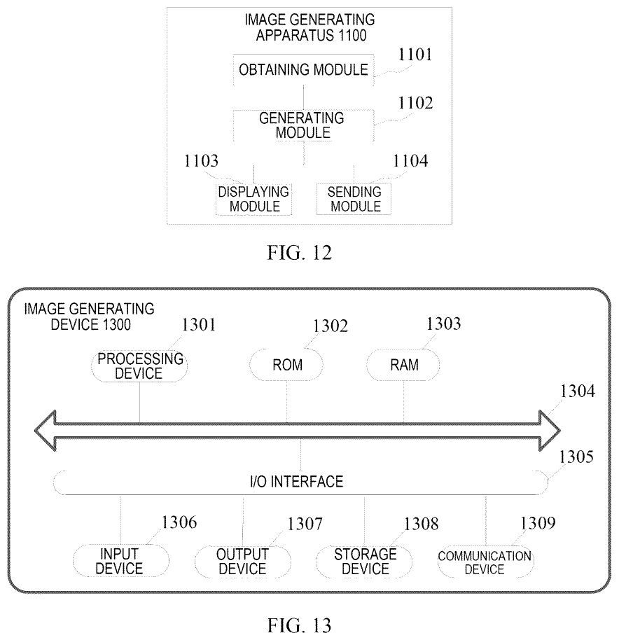

FIG. 12 is a schematic structural diagram of another apparatus for image processing according to an embodiment of the disclosure. Based on the embodiment shown in FIG. 11, referring to FIG. 12, the apparatus 1100 for image processing further includes a displaying module 1103 or a sending module 1104, wherein
the displaying module 1103 is configured to display the target image; or
the sending module 1104 is configured to send the target image to a terminal device.

The apparatus for image processing provided by the embodiment of the disclosure may be configured to perform the technical solutions of the foregoing method embodiments, and implementation principles and technical effects thereof are similar, and details are not described herein again in this embodiment.

FIG. 13 is a schematic structural diagram of a device for image processing according to an embodiment of the disclosure. Referring to FIG. 13, which is a schematic structural diagram of an device 1300 for image processing suitable for implementing embodiments of the disclosure, and the device 1300 for image processing may be a terminal device or a server. The terminal device may include, but is not limited to, a mobile terminal such as a mobile phone, a notebook computer, a digital broadcast receiver, a personal digital assistant (PDA), a portable android device (PAD), a portable multimedia player (PMP), an in-vehicle terminal (for example, an in-vehicle navigation terminal), and a fixed terminal such as a digital TV, a desktop computer, or the like. The device for image processing shown in FIG. 13 is merely an example, and should not impose any limitation on the functions and use ranges of the embodiments of the disclosure.

As shown in FIG. 13, the device 1300 for image processing may include a processing device (for example, a central processing unit, a graphics processor, etc.) 1301, which may perform various appropriate actions and processing according to a program stored in a read only memory (ROM) 1302 or a program loaded into a random access memory (RAM) 1303 from a storage device 1308. In the RAM 1303, various programs and data required by the operations of the device 1300 for image processing are also stored. The processing device 1301, the ROM 1302, and the RAM 1303 are connected to each other through a bus 1304. Input/output (I/O) interface 1305 is also connected to bus 1304.

Generally, the following devices may be connected to the I/O interface 1305: an input device 1306 including, for example, a touch screen, a touch pad, a keyboard, a mouse, a camera, a microphone, an accelerometer, a gyroscope, etc.: an output device 1307 including, for example, a liquid crystal display (LCD), a speaker, a vibrator, etc.: a storage device 1308 including, for example, a magnetic tape, a hard disk, etc.; and a communication device 1309. The communication device 1309 may allow the device 1300 for image processing to communicate wirelessly or wired with other devices to exchange data. Although FIG. 13 illustrates an device 1300 for image processing having various devices, it should be understood that it is not required to implement or have all illustrated devices. More or fewer devices may alternatively be implemented or provided.

In particular, according to an embodiment of the disclosure, the process described above with reference to the flowchart may be implemented as a computer software program. For example, embodiments of the disclosure include a computer program product comprising a computer program embodied on a computer readable medium, the computer program comprising program code for performing the method shown in the flowchart. In such embodiments, the computer program may be downloaded and installed from the network through the communication device 1309, or installed from the storage device 1308, or from the ROM 1302. When the computer program is executed by the processing device 1301, the foregoing functions defined in the method of the embodiments of the disclosure are performed.

It should be noted that the computer-readable medium described above in embodiments of the disclosure may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof. In the disclosure, a computer-readable storage medium may be any tangible medium containing or storing a program that may be used by or in connection with an instruction execution system, apparatus, or device. In the disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables. Radio Frequency (RF), and the like, or any suitable combination thereof.

The computer readable medium described above may be included in the device for image processing, or may be separately present without being assembled into the device for image processing.

The computer-readable medium described above carries one or more programs, and when the one or more programs are executed by the device for image processing, the device for image processing is enabled to perform the method shown in the foregoing embodiments.

Computer program code for performing the operations of the disclosure may be written in one or more programming languages or combination thereof, including object-oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the disclosure may be implemented in software, or may be implemented in hardware. The name of unit does not in some way constitute a limitation on the unit itself. For example, a first obtaining unit may be further described as “a unit obtaining at least two Internet Protocol addresses”.

The functions described above may be performed, at least in part, by one or more hardware logic components. For example, without limitation, the example types of hardware logic components that may be used include: Field-Programmable Gate Array (FPGA). Application Specific Integrated Circuit (ASIC). Application Specific Standard Part (ASSP). System On Chip (SOC). Complex Programmable Logic Device (CPLD), and the like.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

It should be noted that the modification of “a”, “an” and “a plurality of” mentioned in disclosure is illustrative and not limiting, and those skilled in the art should understand these as “one or more” unless the context clearly indicates otherwise.

The names of messages or information exchanged between a plurality of devices in embodiments of the disclosure are for illustrative purposes only and are not intended to limit the scope of such messages or information.

It can be understood that, before the technical solutions disclosed in the embodiments of the disclosure are used, the types, the usage scope, the usage scenario and the like of personal information related to the disclosure should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Thus, the user can autonomously select whether to provide personal information to software or hardware such as a device for image processing, an application program, a server, or a storage medium executing the operations of the technical solution of the disclosure according to the prompt information.

As an optional but non-limiting implementation, in response to receiving an active request from a user, the manner of sending the prompt information to the user may be, for example, a pop-up window, and the prompt information may be presented in a text manner in the pop-up window. In addition, the pop-up window may further carry a selection control for the user to select “agree” or “disagree” to provide personal information to the device for image processing.

It may be understood that the foregoing notification and obtaining a user authorization process is merely illustrative and does not constitute a limitation on implementations of the disclosure, and other manners of meeting related laws and regulations may also be applied to implementations of the disclosure.

It may be understood that the data involved in the technical solution (including but not limited to the data itself, the acquisition or use of the data) should follow the requirements of the corresponding laws and regulations and related rules. The data may include information, parameters, messages, and the like, such as flow cut indication information.

According to a first aspect, an embodiment of the disclosure provides a method of image processing including:
obtaining a base image and a material element; and
generating a target image based on the base image and the material element;
wherein the target image comprises the base image and the material element, a material parameter of the material element in the base image is determined based on the base image and the material element, and the material parameter comprises at least one of a material position, a material size, and a material angle.

In a possible implementation, obtaining the base image and the material element comprises:
obtaining the uploaded base image, and displaying the uploaded base image and a material import control;
in response to an operation on the material import control, displaying a plurality of candidate materials; and
in response to a selection operation performed on the material element in the plurality of candidate materials, obtaining the material element.

In a possible implementation, obtaining the base image and the material element comprises:
displaying a first page comprising a plurality of candidate images and a plurality of candidate materials;
in response to a selection operation input to the base image in the plurality of candidate images, obtaining the base image; and
in response to a selection operation input to the material element in the plurality of candidate materials, obtaining the material element.

In a possible implementation, generating the target image based on the base image and the material element comprises:
determining the material parameter based on a first feature of the base image and a second feature of the material element; and
generating the target image based on the base image, the material element, and the material parameter.

In a possible implementation, determining the material parameter based on the first feature of the base image and the second feature of the material element comprises:
obtaining the first feature and the second feature;
determining a fused feature based on the first feature and the second feature; and
determining the material parameter based on the fused feature.

In a possible implementation, determining the material parameter based on the fused feature comprises:
processing the fused feature by using a predetermined model to obtain a prediction parameter of the material element; and
determining the material parameter based on the prediction parameter.

In a possible implementation, determining the material parameter based on the prediction parameter comprises:
determining error information of the prediction parameter by using a predetermined algorithm;
updating the fused feature based on the error information to obtain an updated fused feature; and
processing the updated fused feature by using the predetermined model to obtain the material parameter.

In a possible implementation, determining the fused feature based on the first feature and the second feature comprises:
obtaining a random vector, and obtaining a random feature of the random vector;
performing fusion processing on the random feature, the first feature, and the second feature to obtain the fused feature.

In a possible implementation, obtaining the first feature comprises:
obtaining a base feature of the base image;
performing saliency region detection on the base image to obtain a saliency region feature of the base image;
wherein the first feature comprises the base feature and the saliency region feature.

In a possible implementation, after generating the target image based on the base image and the material element, the method further comprises:
displaying the target image; or
sending the target image to a terminal device.

According to a second aspect, an embodiment of the disclosure provides an apparatus for image processing, including:
an obtaining module configured to obtain a base image and a material element;
a generating module configured to generate a target image based on the base image and the material element;
wherein the target image comprises the base image and the material element, a material parameter of the material element in the base image is determined based on the base image and the material element, and the material parameter comprises at least one of a material position, a material size, and a material angle.

In a possible implementation, the obtaining module is specifically configured to:
obtain the uploaded base image, and display the uploaded base image and a material import control;
in response to an operation on the material import control, display a plurality of candidate materials; and
in response to a selection operation performed on the material element in the plurality of candidate materials, obtain the material element.

In a possible implementation, the obtaining module is specifically configured to:
display a first page comprising a plurality of candidate images and a plurality of candidate materials;
in response to a selection operation input to the base image in the plurality of candidate images, obtain the base image; and
in response to a selection operation input to the material element in the plurality of candidate materials,
obtain the material element.

In a possible implementation, the generating module is specifically configured to:
determine the material parameter based on a first feature of the base image and a second feature of the material element; and
generate the target image based on the base image, the material element, and the material parameter.

In a possible implementation, the generating module is specifically configured to:
process the fused feature by using a predetermined model to obtain a prediction parameter of the material element; and
determine the material parameter based on the prediction parameter.

In a possible implementation, the generating module is specifically configured to:
determine error information of the prediction parameter by using a predetermined algorithm;
update the fused feature based on the error information to obtain an updated fused feature; and
process the updated fused feature by using the predetermined model to obtain the material parameter.

In a possible implementation, the generating module is specifically configured to:
obtain a random vector, and obtain a random feature of the random vector;
perform fusion processing on the random feature, the first feature, and the second feature to obtain the fused feature.

In a possible implementation, the generating module is specifically configured to:
obtain a base feature of the base image;
perform saliency region detection on the base image to obtain a saliency region feature of the base image;
wherein the first feature comprises the base feature and the saliency region feature.

In a possible implementation, the apparatus for image processing further includes a displaying module or a sending module, wherein
the displaying module is configured to display the target image; or
the sending module is configured to send the target image to a terminal device.

According to a third aspect, an embodiment of the disclosure provides a device for image processing, comprising: a processor and a memory;

the memory storing computer-executable instructions;

the processor executes the computer-executable instructions stored in the memory, so that the processor executes the method of image processing according to the first aspect and various possible implementations of the first aspect.

According to a fourth aspect, an embodiment of the disclosure provides a computer-readable storage medium, wherein the computer-readable storage medium stores computer-executable instructions, which, when executed by a processor, implement the method of image processing according to the first aspect and various possible implementations of the first aspect.

According to a fifth aspect, an embodiment of the disclosure provides a computer program product, comprising a computer program, wherein the computer program is executed by a processor to implement the method of image processing according to the first aspect and various possible implementations of the first aspect.

According to a sixth aspect, an embodiment of the disclosure provides a computer program executed by a processor to implement the method of image processing according to the first aspect and various possible implementations of the first aspect.

The above description is merely an illustration of the preferred embodiments of the disclosure and the principles of the application. It should be understood by those skilled in the art that the scope of the disclosure is not limited to the technical solutions of the specific combination of the above technical features and should also cover other technical solutions formed by any combination of the above technical features or their equivalent features without departing from the above disclosed concept. For example, the above features and the technical features disclosed in the disclosure (but not limited to) having similar functions are replaced with each other to form the technical solution.

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the disclosure. Certain features described in the context of separate embodiments may also be implemented in combination in a single embodiment. Conversely, the various features described in the context of a single embodiment may also be implemented in multiple embodiments cither individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A method of image processing, comprising:
obtaining a base image and a material element; and
generating a target image based on the base image and the material element;
wherein the target image comprises the base image and the material element, a material parameter of the material element in the base image is determined based on the base image and the material element, and the material parameter comprises at least one of a material position, a material size, and a material angle.

2. The method of claim 1, wherein obtaining the base image and the material element comprises:
obtaining the uploaded base image, and displaying the uploaded base image and a material import control;
in response to an operation on the material import control, displaying a plurality of candidate materials; and
in response to a selection operation performed on the material element in the plurality of candidate materials, obtaining the material element.

3. The method of claim 1, wherein obtaining the base image and the material element comprises:
displaying a first page comprising a plurality of candidate images and a plurality of candidate materials;
in response to a selection operation input to the base image in the plurality of candidate images, obtaining the base image; and
in response to a selection operation input to the material element in the plurality of candidate materials, obtaining the material element.

4. The method of claim 1, wherein generating the target image based on the base image and the material element comprises:
determining the material parameter based on a first feature of the base image and a second feature of the material element; and
generating the target image based on the base image, the material element, and the material parameter.

5. The method of claim 4, wherein determining the material parameter based on the first feature of the base image and the second feature of the material element comprises:
obtaining the first feature and the second feature;
determining a fused feature based on the first feature and the second feature; and
determining the material parameter based on the fused feature.

6. The method of claim 5, wherein determining the material parameter based on the fused feature comprises:
processing the fused feature by using a predetermined model to obtain a prediction parameter of the material element; and
determining the material parameter based on the prediction parameter.

7. The method of claim 6, wherein determining the material parameter based on the prediction parameter comprises:
determining error information of the prediction parameter by using a predetermined algorithm;
updating the fused feature based on the error information to obtain an updated fused feature; and
processing the updated fused feature by using the predetermined model to obtain the material parameter.

8. The method of claim 5, wherein determining the fused feature based on the first feature and the second feature comprises:
obtaining a random vector, and obtaining a random feature of the random vector;
performing fusion processing on the random feature, the first feature, and the second feature to obtain the fused feature.

9. The method of claim 5, wherein obtaining the first feature comprises:
obtaining a base feature of the base image;
performing saliency region detection on the base image to obtain a saliency region feature of the base image;
wherein the first feature comprises the base feature and the saliency region feature.

10. The method of claim 1, further comprises: after generating the target image based on the base image and the material element,
displaying the target image; or
sending the target image to a terminal device.

11. (canceled)

12. A device for image processing device, comprising: a processor and a memory;
the memory storing computer-executable instructions;
the processor executes the computer-executable instructions stored in the memory, so that the processor executes acts comprising:
obtaining a base image and a material element; and
generating a target image based on the base image and the material element;
wherein the target image comprises the base image and the material element, a material parameter of the material element in the base image is determined based on the base image and the material element, and the material parameter comprises at least one of a material position, a material size, and a material angle.

13. A non-transitory computer-readable storage medium, wherein the computer-readable storage medium stores computer-executable instructions, which, when executed by a processor, implement acts comprising:
obtaining a base image and a material element; and
generating a target image based on the base image and the material element;
wherein the target image comprises the base image and the material element, a material parameter of the material element in the base image is determined based on the base image and the material element, and the material parameter comprises at least one of a material position, a material size, and a material angle.

14. (canceled)

15. (canceled)

16. The device of claim 12, wherein obtaining the base image and the material element comprises:
obtaining the uploaded base image, and displaying the uploaded base image and a material import control;
in response to an operation on the material import control, displaying a plurality of candidate materials; and
in response to a selection operation performed on the material element in the plurality of candidate materials, obtaining the material element.

17. The device of claim 12, wherein obtaining the base image and the material element comprises:
displaying a first page comprising a plurality of candidate images and a plurality of candidate materials;
in response to a selection operation input to the base image in the plurality of candidate images, obtaining the base image; and
in response to a selection operation input to the material element in the plurality of candidate materials, obtaining the material element.

18. The device of claim 12, wherein generating the target image based on the base image and the material element comprises:
determining the material parameter based on a first feature of the base image and a second feature of the material element; and
generating the target image based on the base image, the material element, and the material parameter.

19. The device of claim 18, wherein determining the material parameter based on the first feature of the base image and the second feature of the material element comprises:
obtaining the first feature and the second feature;
determining a fused feature based on the first feature and the second feature; and
determining the material parameter based on the fused feature.

20. The device of claim 19, wherein determining the material parameter based on the fused feature comprises:
processing the fused feature by using a pre-determined model to obtain a prediction parameter of the material element; and
determining the material parameter based on the prediction parameter.

21. The device of claim 20, wherein determining the material parameter based on the prediction parameter comprises:
determining error information of the prediction parameter by using a predetermined algorithm;
updating the fused feature based on the error information to obtain an updated fused feature; and
processing the updated fused feature by using the predetermined model to obtain the material parameter.

22. The device of claim 19, wherein determining the fused feature based on the first feature and the second feature comprises:
obtaining a random vector, and obtaining a random feature of the random vector;
performing fusion processing on the random feature, the first feature, and the second feature to obtain the fused feature.

23. The device of claim 19, wherein obtaining the first feature comprises:
obtaining a base feature of the base image;
performing saliency region detection on the base image to obtain a saliency region feature of the base image;
wherein the first feature comprises the base feature and the saliency region feature.
